(19) United States
(12) Patent Application Publication
(10) Pub. No.: US 2026/0127393 A1
(43) Pub. Date: May 7, 2026

(54) Computing System and Method for Answering Questions About Construction Documents Using Generative Artificial Intelligence

(71) Applicant: Procore Technologies, Inc., Carpinteria, CA (US)

(72) Inventors: Reza Mohebbian, Ontario (CA); Jiazi Liu, Ontario (CA); Mohammad Mostafa Soltani, Ontario (CA); Azadeh Yazdan Panah Gohar Rizi, Ontario (CA)

(21) Appl. No.: 18/936,650

(22) Filed: Nov. 4, 2024

(51) Int. Cl. G06F 40/58; G06Q 10/10; G06Q 50/08

(52) U.S. Cl. CPC G06F 40/58; G06Q 10/103; G06Q 50/08

(57) ABSTRACT

An example computing platform is configured to: (i) receive from a client device associated with a user, a question regarding a construction project, (ii) receive, from the client device associated with the user, one or more construction documents related to the construction project, (iii) based on the received question and the one or more construction documents, prepare input data for a generative AI model architecture, (iv) provide the prepared input data to the generative AI model architecture to cause the generative AI model to produce a response to the question, and (v) cause the client device to present the produced response to the user.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### OVERVIEW

Disclosed herein is new software technology for using generative artificial intelligence (AI) in order to answer questions about a construction project. At a high level, the disclosed software technology may involve a new generative AI model architecture. This architecture may comprise, among other aspects, pre-processing functionality, transformer functionality for producing image embeddings, transformer functionality for producing text embeddings, dimension reduction functionality for reducing the embedding dimension of the image embedding, normalization functionality for producing normalized image embeddings, feed forward neural network expert functionality for producing transformed imaged embeddings, feed forward neural network expert functionality for producing transformed text embeddings, learnable temperature functionality for determining temperature parameters by which to scale the transformed embeddings, router functionality to combine the transformed embeddings according to the temperature parameters, and output transformer technology for producing a response based on the combined transformed embeddings.

In one aspect, the disclosed technology may take the form of a method to be carried out by a computing system that involves (i) receiving from a client device associated with a user, a question regarding a construction project, (ii) receiving, from the client device associated with the user, one or more construction documents related to the construction project, (iii) based on the received question and the one or more construction documents, preparing input data for a generative AI model, (iv) providing the prepared input data to the generative AI model architecture to cause the generative AI model to produce a response to the question, and (v) causing the client device to present the produced response to the user.

In yet another aspect, disclosed herein is a computing platform that includes at least one communication interface, at least one processor, at least one non-transitory computer-readable medium, and program instructions stored on the at least one non-transitory computer-readable medium that, when executed by the at least one processor, cause the computing platform to carry out the functions disclosed herein, including (but not limited to) any of the functions of the foregoing method.

In yet another aspect, disclosed herein is a non-transitory computer-readable medium provisioned with program instructions that, when executed by at least one processor, cause a computing platform to carry out the functions disclosed herein, including (but not limited to) any of the functions of the foregoing method.

One of ordinary skill in the art will appreciate these as well as numerous other aspects in reading the following disclosure.

### BRIEF DESCRIPTION OF THE DRAWINGS

FIG. 1 depicts an example network environment in which a construction management software application may be implemented, according to the present disclosure.

FIG. 2 depicts an illustrative example of a generative AI model architecture, according to the present disclosure.

FIG. 3 depicts example functionality of the disclosed software technology in the form of a flow diagram, according to the present disclosure.

FIG. 4 depicts example functionality that may be used to train generative AI model architecture in the form of a flow diagram, according to the present disclosure.

FIG. 5 is a simplified block diagram that illustrates some structural components that may be included in an example computing platform, according to the present disclosure.

FIG. 6 is a simplified block diagram that illustrates some structural components that may be included in an example client device, according to the present disclosure.

### DETAILED DESCRIPTION

The following disclosure refers to the accompanying figures and several examples. A person of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

Construction management today is often performed through the use of software applications, such as the software application provided by Procore Technologies, Inc.® (“Procore,” which is the applicant of the present disclosure). These software applications generally provide users the ability to create, store, view, and/or interact with various types of data related to a construction project, such as specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project, etc.), directories, invoices, timesheets, meeting minutes, sensor data, and daily logs (e.g., which record information about each day work is done at a work site of the construction project), among many other examples of project data that may be stored for a construction project.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. This form of a software application may be referred to as a client-server application or a software-as-a-service (SaaS) application, among other possibilities. As another possible implementation, a construction management software application may include front-end client software that runs on client devices without interaction with a back-end platform. These software applications may take other forms as well.

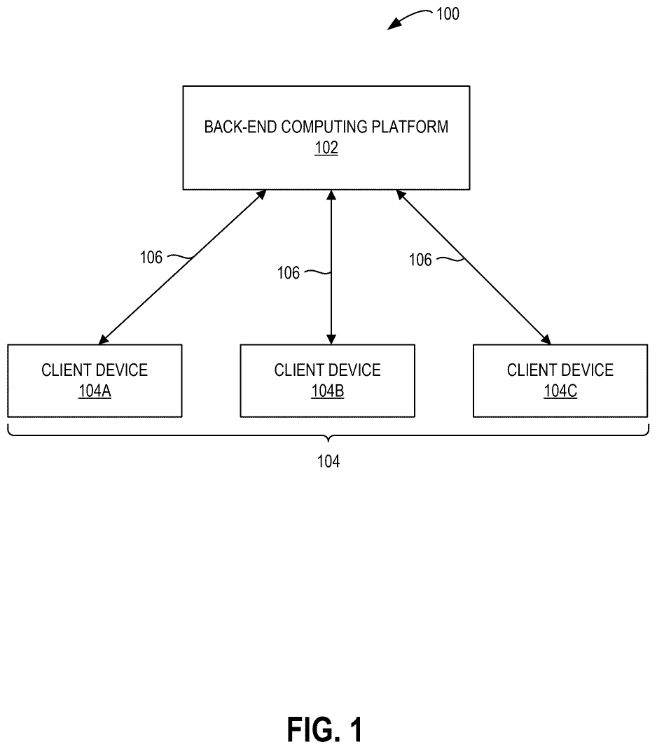

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which include the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage systems, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each of the communication paths 106 between the back-end computing platform 102 and one of the client devices 104 may generally comprise one or more communication networks and/or communications links, which may take any of various forms. For instance, each of the respective communication paths 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each of the respective communication paths 106 with the back-end computing platform 102 may be wireless, wired, or some combination thereof, and may carry data according to any of various different communication protocols. Further yet, communications over each of the respective communication paths 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data source—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

Software applications as a general matter are beginning to incorporate new functionality in order to provide users with advanced features. One type of new functionality that is beginning to be incorporated in software applications is generative artificial intelligence (generative AI). Briefly, generative AI refers to software functionality capable of generating content, such as text, typically in response to a prompt from a user. Generative AI is generally comprised of a software program, sometimes also referred to as a “model,” which is trained, through a machine-learning process, to provide a desired type of output. Typically, a set or sets of training data is provided to the model and the model processes the training data through neural networks in order to develop a trained model. Once a model is trained, users can input queries or prompts to the model and the model will generate an output based on the query.

Construction management software tools are beginning to incorporate generative AI functionality as well in order to provide advanced features specific to construction management. One such advanced feature that is presently desired in a construction management software tool is the ability to answer questions related to a construction project based on construction documents, such as construction drawings. In other words, it is desirable to have a software tool that can receive a construction drawing for a construction project and a query relating to the construction project, like “what is the square footage of the build location?” and provide an answer along the lines of “4,500 sq. ft.”

There are existing generative AI techniques that have been used to provide functionality for answering questions based on documents or images, but they tend not to be well-suited in the construction management context. For example, one technique used for answering questions based on images is Visual Question Answering (VQA). VQA refers to a type of generative AI model that is capable of receiving inputs in the form of an image and a natural language question about the content of the image and producing an output in the form of a natural language answer to the question. In this respect, and by way of example, a user may provide a VQA model with an image of patrons dining in a restaurant and provide the question “how many patrons are dining?” The VQA model will then analyze the image, attempt to identify the number of patrons dining, and then return the answer in a natural language response to the user.

The VQA technique, though powerful, is not well-suited to being used in the construction management context. This is because the VQA technique tends to only be capable of answering relatively basic questions about the content of images, like what the setting of the image is, what the content of the image is, or what actions are being depicted in the image, among other similar examples. The VQA technique tends not to be able to understand the information contained within construction drawings, for instance, because construction drawings tend to incorporate both visual and textual information, where the appropriate interpretation of visual information may depend on the textual information. By way of example, a construction drawing may depict a wall that is six inches long. However, the scale of the drawing may be one inch for every one foot. In this respect, VQA techniques tend not to be able to interpret that the drawing is depicting a wall that is six feet in length instead of a wall that is six inches in length.

Another technique used for answering questions based on the content of a document is Document Visual question Answering (DocVQA). The DocVQA technique extended the capabilities of the VQA technique to generally text-based documents that may contain some additional graphical content, like tables or charts as well as text-based documents that contain information organized into columnar format. In this respect, and by way of example, the DocVQA technique may be able to recognize the format of a given document as an invoice and then be able to answer a question like “what is the total of the billed items?” by identifying the line-item prices and then summing them to obtain an answer.

The DocVQA technique, though powerful still, is similarly not well-suited to being used in the construction management context. This is because the DocVQA technique tends to only be capable of answering questions concerning the content of the document itself but remains unable to interpret more complicated spatial relationships or construction-specific visual indicators that are typically present in construction drawings. In addition, though construction drawings typically contain some text, they tend to assume the reader already has a basic understanding of what is represented visually by the drawing and for this reason tend not to annotate every aspect of the drawing with the type of specificity typically required by the DocVQA technique. By way of example, a construction drawing may represent a set of stairs with a visual indicator recognizable to a construction professional as a set of stairs but which otherwise appears as simply a square with a set of parallel lines contained therein. Thus, the DocVQA technique may not typically be capable of responding to the question “what is the minimum wall clearance we need for all the sets of stairs in this project?” by identifying where the stairs are depicted in the drawing, identifying the nearest walls, and calculating the minimum distance between the stairs and the walls in order to return an acceptable answer to the user.

Accordingly, and in order to address at least these shortcomings as well as potentially others, disclosed herein is a new generative AI model architecture for a software tool that utilizes generative AI functionality in order to answer construction-related questions about a construction project after being provided with one or more construction documents, like drawings. At a high level, this new generative AI model architecture functions to (i) separate the image portion of the provided document from the textual portions of the provided document and the user prompt, (ii) apply separate pre-neural network software processes to each of the image portion and the textual portions, including, transformations, dimension reductions, and applying L2 norm parameterizations, (iii) engage specific feed-forward neural network “experts” to separately process each of the image portion and the textual portions, (iv) apply a “learnable temperature to each of the image portion and the textual portions, (v) utilize a router to combine the outputs of the experts in accordance with the learnable temperature, and then (vi) apply a transformation to the combined output in order to produce a context-specific response to the user's question. By utilizing the disclosed generative AI model architecture, a software tool will be configured to receive and processing high-resolution construction-project-specific documents, like drawings, understand the visual elements depicted therein as well as construction-specific contextual elements, like scale, and then formulate a response to a construction-specific question. In this way, the generative AI model architecture advances over previous, more rudimentary techniques for answering questions based on documents and images, like VQA or DocVQA.

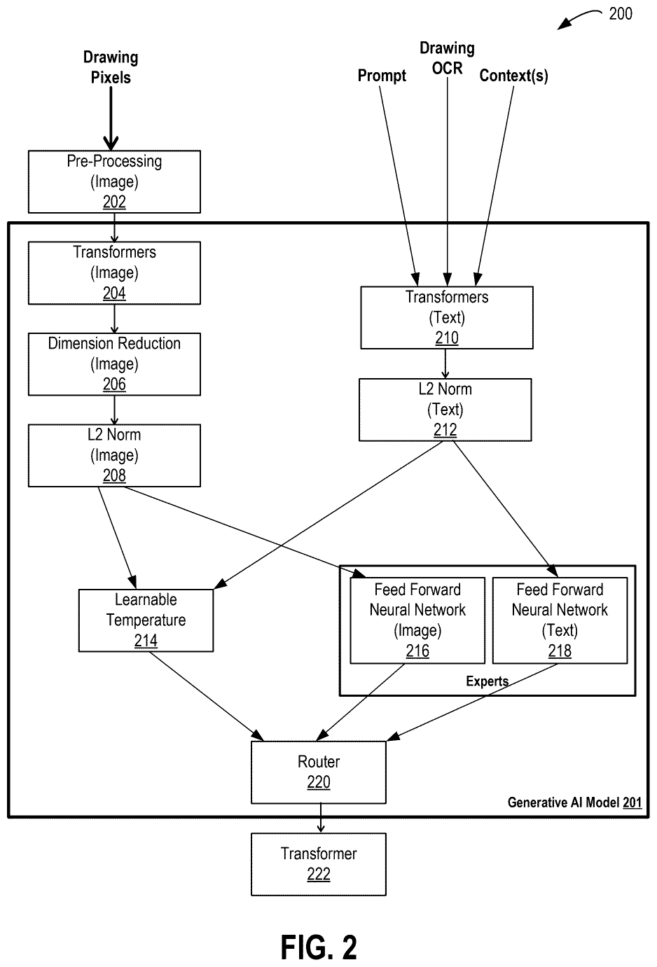

Turning now to FIG. 2A, depicted herein is one example of a software architecture 200 that includes a generative AI model architecture 201, which together may be utilized to generate responses to construction-related questions based on construction documents. As shown, the software architecture 200 includes pre-processing functions represented by block 202 and post-processing functions represented by block 222. As further shown, the software architecture 200 includes a generative AI model architecture 201, which includes certain processing functions represented by blocks 204-220. Each of the functional steps carried out by the software architecture 200 and more specifically by the generative AI model architecture 201 in order to generate responses to construction-related questions based on construction documents is described below.

In operation, the software architecture 200 may be presented with at least one or more construction drawings and a question from a user relating to the construction drawing (referred to herein as a “prompt”). Because the typical use case for the software architecture 200 is its ability to generate responses to construction-related questions based on construction drawings, the operation of the software architecture 200 is described with reference to the presentation of a construction drawing; however, those skilled in the art will understand that the software architecture 200 may be also be presented with construction documents other than drawings.

To facilitate presenting the software architecture 200 with a construction drawing, a back-end computing platform (such as back-end computing platform 102 (FIG. 1)) may cause a client device (such as one of client devices 104A-C (FIG. 1)) to present a user with a graphical user interface (GUI) through which the user may (i) provide the back-end platform with the construction drawing (e.g., through a drag-and-drop mechanism, among other possibilities) and (ii) enter a natural language question relating to the construction drawing.

Upon being presented with a construction drawing, the software architecture 200 may engage in two initial steps. First, the software architecture 200 is configured to separate the pixel data in the drawing from any text contained in the drawing. In this respect, certain pre-processing steps (not depicted in the software architecture 200) may operate to perform optical character recognition (OCR) on the drawing and thereby extract any text contained in the drawing. Second, the architecture 200 is configured to route the pixel data to pre-processing functions 202 and route the prompt, the textual data, and contextual data to the transformer function 210. Description will first be made of the functions involving the pixel data and, following that, of the functions involving the textual data.

As mentioned, the architecture 200 is configured to apply pre-processing functions to the pixel data at pre-processing block 202. Here, the architecture 200 is configured to present the pre-processing block 202 with pixel data, which may be represented in a three-dimensional matrix of pixel data. In this respect, one dimension of the matrix may represent the horizontal position within the drawing of the pixel data, another dimension of the matrix may represent the vertical position within the drawing of the pixel data, and the third dimension of the matrix may represent the color value in the form of red-green-blue (RGB) data. Pixel data may be represented in other forms as well.

The pre-processing block 202 is generally configured to apply certain pre-processing functions to the pixel data prior to the pixel data being provided to the generative AI functions. Another pre-processing function that may be applied by the pre-processing block 202 is a resizing function. In operation, the resizing function may operate to resize the pixel data to a threshold size while keeping the aspect ratio of the original drawing. By way of example, the resizing function may operate to resize the pixel data to contain data for 2,500 pixels, although other threshold numbers of pixels are possible. The resizing function may also operate to resize the pixel data but maintain the aspect ratio of the overall drawing. In line with this example, if the pixel data for the drawing is represented by a three-dimensional matrix of pixels and reflects an aspect ratio of 4:3, then the resized pixel data will be a resized three-dimensional matrix of pixels containing data representing 2,500 pixels at an aspect ratio of 4:3. In this example, the resized matrix will contain pixel data representing about 58 pixels by 43 pixels. In another example, the resizing function may operate to resize the pixel data to contain data for 1,024 pixels. In line with this example, if the pixel data is represented by a three-dimensional matrix of pixels and reflects an aspect ratio of 1:1, then the resized pixel data will be a resized three-dimensional matrix of pixels containing data representing 1,024 pixels at an aspect ratio of 1:1. In this example, the resized matrix will contain pixel data representing 32 pixels by 32 pixels. Other examples of resizing pixel data are possible as well.

Another pre-processing function that may be applied by the pre-processing block 202 is a patch function, which splits the pixel data into subsets of pixel data, where each subset of pixel data will contain pixel data for a different portion (or “patch”) of the drawing. In this respect, each subset of the pixel data is referred to herein as an “image patch.” In one embodiment, the patch function may operate to split the pixel data into 200 patches of pixel data, with each patch containing the pixel data for a unique portion (or “patch”) of the drawing. In other embodiments, other numbers of patches are possible. In embodiments in which the pixel data is contained in a three-dimensional matrix, the patch function operates to split the three-dimensional matrix into a number of three-dimensional sub-matrices, where each sub-matrix contains the pixel data corresponding to a different patch of the drawing.

After the pre-processing functions are complete, the separate image patches are input into a set of transformers 204. The transformers 204 are configured to receive the images patches and operate to produce a set of image embeddings, with each image embedding taking the form of a three-dimensional (3D) tensor. In order to produce the image embeddings, the transformers 204 may take the form of a multi-head attention transformer configured to produce embeddings for each patch of the image.

At a high-level, a transformer is a processing step or set of processing steps in generative AI models designed to convert input data into a form that is usable by the remaining processing functions of the AI model. Generally, a transformer functions to at least convert the input data into token data and embed the token data with vector representations, which are then usable by the remaining functions of the generative AI model. Converting the input data into token data refers to a process of assigning the input data or portions of the input data to tokens, which are numerical representations of the input data. Embedding the token data with vector representations refers to a process of converting each token into a vector (i.e., a one by n matrix of numbers), where the vectors represent an initial encoding of the meaning of the input data. In this way, and at a high level, the transformer is configured to apply mathematical transformations and encodings to the input data so that the remainder of the generative AI model can understand the meaning of the input data and apply additional mathematical transformations in order to generate an output responsive to the input.

Transformers may be configured to perform other functions as well. One additional type of function that a transformer may perform is what is referred to as at attention process or set of attention processes. An attention process is a set of additional encoding processes that are designed to further transform the vectors in ways that encode the vectors with additional meaning discernable from the input data. As an example, one attention process may apply a set of transformations to the vectors based on their position within the input data. As another example, another attention process may apply a transformation to a given vector based on which vectors precede the given vector and which vectors follow the given vector. In this way, the attention processes change the initial vector embeddings in ways designed to encode even more meaning of the input data into the vectors themselves. Transformers that utilize multiple attention processes like this are referred to as multi-head attention transformers.

In the architecture 200, transformers 204 are configured to first receive the image patches from the pre-processing function 202. The transformers 204 are configured to then convert each image patch into an image embedding by engaging in one or more mathematical processes through which the pixel data represented by the image patch is converted into vector embeddings designed to encode position and feature data into the image patches. In operation, this may occur by first flattening each patch into an initial vector. By way of example, if an image patch is represented by a 16 by 16 by 3 3D matrix (which would contain data for 16 pixels in the horizontal direction, 16 pixels in the vertical direction, and color data in RGB form in the third dimension), this patch would be flattened into a one by 768 vector.

Next, each flattened patch may undergo a linear projection transformation or a series of linear projection transformations, which is a mathematical computation applied to each flattened image patch vector designed to convert respective portions of the image patch into tokens and then designed to encode the tokens into higher dimensional vector data. The set of encoded vectors for each token of the image patch is referred to as an embedding and the collection of embeddings for a given patch is referred to as an embedded image patch. As mentioned above, by generating these embeddings, the transformers 204 encode an initial meaning or set of meanings to each image patch. This initial meaning is an attempt to mathematically represent the feature or features present in the image patch. By way of a simple example, if an image patch depicted a wall, then the transformers 204 would attempt to encode the image patch with data representing the type of wall depicted, the size of the wall depicted, how much or how little of the wall is depicted, the direction the wall is running, among other possible features. Similarly, if the image patch depicted a set of stairs, then the transformers 204 would attempt to encode the image patch with data representing the type of stairs depicted, the size of the stairs, how much or how little of the stairs are depicted, the direction the stairs run, among other possible features. As a result of these mathematical computations, the flattened image patch vector becomes a matrix, where the number of columns in the matrix is represented by the number of tokens identified in the image and the number of rows of the matrix is the depth of the embedding dimension (i.e., the size of each vector constituting the embedding).

It is possible that an image patch may depict more than one feature, and in some cases several features or portions of several features. In this way, the matrix will contain a set of vector embeddings for each token, where the vector embedding contains different values that together define a high-dimensional vector that represents how much or how little of each possible feature the image patch depicts. By way of example, transformers 204 may encode token data for 64 possible tokens with an embedding dimension of size 512. In this example, the linear projection would result in a 64 by 512 matrix, where each column of the matrix is a one by 512 vector representing a vector encoding for a given one of the 64 tokens assigned to the image patch. Other numbers of tokens are possible, as are other embedding dimensions, which would result in larger or smaller matrices, as the case may be. The number of features encoded by the transformers 204 is a trainable parameter, which will be discussed later herein.

As mentioned above, transformers may be configured to engage in attention processes. In this respect, transformers 204 may be configured to engage in additional mathematical computations involving the vectors of the image embeddings that are designed to further transform the vectors based on information present in the other vectors of the same image patch as well as other vectors in other patches. Through engaging in these attention processes, the transformers 204 further transform the vectors of a given image patch embedding to encode additional meaning or a potentially a more accurate meaning. Consider an example in which an image patch depicts a line. In the abstract, it may be difficult to discern what this line represents. Among other possible examples, the line could represent a wall, an environmental boundary, or some other component of the construction project, like a duct or pipe. However, through consideration of neighboring image patches, through which the line may continue, for example, in the shape of a square, it may be understood that all the lines together in these image patches combine to represent a room boundary. In this respect, the mathematical computations performed by the transformers 204 in the attention processes are designed to recognize patterns in the respective image embeddings and are configured to transform the respective embeddings for the tokens representing each of these lines in each of the patches in order to more fully represent that these lines are room boundaries.

Separately, each initial flattened image patch vector undergoes a positional embedding, which is a mathematical computation applied to each flattened image patch vector designed to encode position data into each image patch. The transformers 204 encode position data into each image patch by engaging in a mathematical computation designed to represent the relative position within each image patch each of each feature depicted within the image patch. By way of example, if an image patch depicted a wall in the upper left of the image patch, then the transformers 204 would attempt to encode the image patch with position data indicating that the wall feature was positioned in the upper left of the image patch. As a result of this mathematical computation, the flattened image patch vector becomes a position-embedded matrix, where the number of rows in the position-embedded matrix is the same as the number of rows in the matrix produced by the linear projection.

Next, the transformers 204 are configured to construct a position augmented embedding by adding together for each image patch, the image embedding produced by the linear projection and the positional embedding to result in a position-augmented embedding for each image patch. The resultant matrix produced by the transformers 204, therefore, is a tensor, where the dimensions of the tensor are (i) the number of possible tokens, (ii) the size of the embedding vector, and (iii) the total number of image patches for the original drawing. In the example mentioned above, the dimensions of the tensor produced by the transformers 204 would be 64 (number of possible tokens) by 512 (size of the embedding vector) by 200 (number of patches). However, other examples are possible as well.

After the transformer functions are complete, the tensor is input into a dimension reduction function 206. The dimension reduction function 206 is configured to reduce the embedding dimension of the tensor in order to make subsequent operations of the architecture 200 more efficient while retaining enough data in the tensor in order for the subsequent operations of the architecture 200 to produce a response to the query. In operation, the dimension reduction function 206 may apply a mathematical computation to the tensor designed reduce the size the size of the embedding dimension (i.e., the size of the vector embedding representing the token data) of the tensor while still ensuring the token data captures the meaningful properties of the data represented in each image patch. The dimension reduction function 206 may be configured to do this by removing or suppressing irrelevant data and/or by combining data contained in multiple dimensions and representing it in a single dimension. In practice, the dimension reduction function 206 may utilize a technique referred to as “simple Linear Layer” in order to reduce the embedding dimension. By way of example, in some embodiments, the dimension reduction function 206 reduces the size of the embedding dimension of the tensor from 512 dimensions (i.e., token vectors with a size of 512) down to 50 dimensions (i.e., token vectors with a size of 50), although other dimensions are possible as well.

After the dimension reduction function is complete, the tensor with reduced dimensions is input into a normalizing function 208 that computes a normalization, such as the L2 norm, of each feature present in the image embeddings of the tensor. At a high level, a normalizing function is a mathematical operation performed on a vector designed to compute a non-negative value representing the vector's size. In this way, the normalizing function can be used on a set of vectors in order to provide a quantitative measure of the similarity or difference between the vectors of the set. In the architecture 200, the normalizing function 208 is configured to perform a mathematical computation to compute the L2 norm across each dimension in the vectors image embeddings. In other words, the normalizing function 208 is configured to calculate a respective L2 norm value for each row of the tensor. Each L2 norm value will therefore represent a quantitative representation of the magnitude of each feature present in the image embeddings. As a result of this operation, the normalizing function 208 produces a resultant matrix with the same dimensions as the initial tensor input into the normalizing function 208 but where the resultant tensor is normalized along the embedding dimension.

Before describing the remaining functional blocks of the architecture 200, which include the learnable temperature function 214, the feed forward neural networks 216,218, the router function 220, and the transformer 222, description will continue with the transformers 210 and L2 normalization 212 functions, which are carried out on the text portions of the input to architecture 200. As described above, upon being presented with a construction drawing, the software architecture 200 may engage in two initial steps. First, the software architecture 200 is configured to separate the pixel data in the drawing from any text contained in the drawing. In this respect, certain pre-processing steps (not depicted in the software architecture 200) may operate to perform optical character recognition (OCR) on the drawing and thereby extract any text contained in the drawing. Second, the architecture 200 is configured to route the pixel data to pre-processing functions 202 (which has already been described) and route the prompt, the textual data, and additional contextual data to the transformer function 210 (which will now be described).

As mentioned, the prompt, textual data extracted, via an OCR process for instance, and additional contextual data is routed to the transformer function 210. The architecture 200 may obtain additional contextual data for the construction project from the back-end computing platform 102 or other computing platforms. To facilitate obtaining additional contextual data, architecture 200 may be configured to cause the back-end computing platform 102 to communicate with other software applications via respective APIs or the like in order to issue one or more requests for additional contextual data associated with the construction project that may be accessible to or within these other software applications. In response to such a request, these other software applications may retrieve and transmit to the architecture 200 certain additional contextual data associated with the construction project. Examples of additional contextual data that the architecture 200 may receive may include materials lists, change orders, budget data, communications, invoices, directories, time sheets, requests for information, reports, etc.

Like the transformers 204, transformers 210 are configured to receive text strings corresponding to (i) the prompt, (ii) textual data associated with the drawing, and (iii) additional contextual data received from back-end computing platform 102 or another computing platform and operate to produce respective sets of embeddings, with each embedding taking the form of a tensor. The transformers 210 are configured to produce these embeddings by first converting each text string into a set of token data and then engaging in one or more mathematical processes through which the token data is converted into embeddings designed to encode position and feature data.

In operation, this may occur by first engaging in a linear projection operation through which the transformers 210 assign tokens (i.e., numerical representations) to words or portions of words that appear in the text string and then perform mathematical computations on the tokens to produce a vector for each token, where the collection of vectors for a given set of tokens are referred to as an embedding. As mentioned above, the process of assigning tokens and then performing mathematical computations on the tokens results in encoding an initial meaning or set of meanings to each token. This initial meaning is an attempt to mathematically represent the meaning of each word or portions of words in each text string. As a result of this mathematical computation, a matrix is produced, where the number of columns in the matrix is represented by the number of tokens identified in the text string and the number of rows of the matrix is the depth of the embedding dimension (i.e., the size of the vector, which represents the number of features representing the token data). By way of example, transformers 210 may encode token data with an embedding dimension of 512. In this example, the linear projection would result in an n by 512 matrix, where n is the number of tokens assigned to the text string and each column of the matrix is a one by 512 vector representing a vector encoding for a given one of the assigned tokens. Other embedding dimensions, which would result in larger or smaller matrices, as the case may be.

The resultant matrices for each of the text strings are then input into a normalizing function 212 that computes a normalization, such as the L2 norm, of each vector present in each resultant matrix. In the architecture 200, the normalizing function 212 is configured to perform a mathematical computation to compute the L2 norm across each vector present in the resultant matrices. In other words, the normalizing function 212 is configured to calculate a respective L2 norm value for each row of each matrix. Each L2 norm value will therefore represent a quantitative representation of the magnitude of each feature present in the text embeddings. As a result of this operation, the normalizing function 212 produces a resultant matrix with the same dimensions as the initial matrices but where each resultant matrix is normalized along the embedding dimension.

The resultant matrices from the normalization function 212 and the resultant tensors from the normalization function 208 are then passed to both the learnable temperature function 214 and respective expert processing functions. In particular, the resultant tensor from the normalization function 208 (which represent image embeddings) is passed to feed forward neural networks 216 (referred to as an “image expert”) in order to process the image embeddings, whereas the resultant textual embeddings from the normalization function 212 are passed to respective feed forward neural networks 218 (referred to as a “textual expert”) in order to process the textual embeddings.

At a high level, the respective feed forward neural networks 216, 218 are trained processes that are configured to apply layers of mathematical computation on the respective embeddings in order to produce a set of transformed embeddings. The process through which each expert receives a respective set of embeddings and produces a respective set of transformed embeddings can be conceptually thought of as representing the experts'attempt at understanding what features are depicted in the drawing, what those features represent in words, what features are represented by the OCR textual information and/or any additional contextual information, and what information the user is requesting via the prompt. In this respect, the transformed embeddings represent information designed to be responsive to the prompt. Through the remainder of the processes of architecture 200, the transformed embeddings will be combined and transformed into a natural language output responsive to the user's prompt.

In operation, the normalized image embeddings in the form of a tensor are provided to the feed forward neural network 216. The feed forward neural network 216 processes each embedding in the tensor independently. In one embodiment, and for each embedding in the tensor, the feed forward neural network 216 engages in a first mathematical computation involving the embedding, which takes the form of a linear transformations of the embedding to produce a first-transformed embedding. Following this, the feed forward neural network 216 engages in a second mathematical computation involving the first-transformed embedding, which takes the form of a non-linear activation function and thus produces a second-transformed embedding. In some embodiments, the feed forward neural network 216 applies a rectified linear unit activation function (referred to as ReLU), however other non-linear activation functions are possible. Following this, the feed forward neural network 216 engages in a third mathematical computation involving the second-transformed embedding, which takes the form of another linear transformation, which produces a third-transformed embedding.

The mathematical computations performed by the feed forward neural network are based on an “initialization state” of the feed forward network. The initialization state of the feed forward neural network refers to the initial set of model parameters, such as weights or biases, that the feed forward neural network uses in its attempt to classify the embeddings via the mathematical computations it performs on the embeddings. The initialization state of a given feed forward network is generally determined as a result of training the model. In this respect, after undergoing a training process, a given feed forward neural network will be configured in a given initialization state and will be configured to perform mathematical computations on the embeddings in accordance with the feed forward neural network's initialization state. In some embodiments, the feed forward neural networks are initialized during training using various initialization techniques, including by way of example, random initialization, He initialization, or pretrained weights, among other possibilities.

The transformed embeddings produced by the feed forward neural networks can be thought of as a set of encoded vectors that represent a series of probabilities across the entire token space, where each individual probability is referred to as a logit. A logit is a numerical value representing the model's confidence that a given token is the next token. In other words, for each vector in the embedding, the feed forward neural network is configured to, for each possible token that the architecture 200 understands, determine a respective logit corresponding to that token.

As a result of this processing by the feed forward neural network 216, the transformed set of embeddings takes the form of a tensor with the following dimensions: N, S, D, where N is the number of image patches being processed, S is the number of tokens encoded in the image embeddings, and D is the embedding dimension, which is the size of the vector representing the token data.

In some embodiments, feed forward neural network 216 may comprise multiple sets of independent feed forward neural networks, with each feed forward neural network being initialized with a different initialization state. In these embodiments, a respective image embedding is processed in parallel by each independent feed forward neural network by engaging in the same types of mathematical computations described in the preceding paragraph, which results in a set of transformed image embeddings for each initial image embedding provided to the feed forward neural network 216. In this embodiment, as a result of processing by the multiple feed forward neural networks 216, the transformed embeddings take the form of a tensor with the following dimensions: N, S, M*D, where N is the number of image patches being processed, S is the number of tokens encoded in the image embeddings, and M*D is a multiplication of (i) the size of the embedding dimension of each independent feed forward neural network and (ii) the number of independent feed forward neural networks.

Similarly, the textual embeddings in the form of a set of matrices are provided to the feed forward neural network 218. The feed forward neural network 218 processes each set of embeddings independently. In one embodiment, and for each set of textual embeddings, the feed forward neural network 218 engages in a first mathematical computation involving the embeddings, which takes the form of a linear transformations of the embeddings to produce a first-transformed set of embeddings. Following this, the feed forward neural network 218 engages in a second mathematical computation involving the first-transformed set of embeddings, which takes the form of a non-linear activation function and thus produces a second-transformed set of embeddings. In some embodiments, the feed forward neural network 216 applies a ReLU function, however other non-linear activation functions are possible. Following this, the feed forward neural network 218 engages in a third mathematical computation involving the second-transformed set of embeddings, which takes the form of another linear transformation and produces a third-transformed set of embeddings. Like the transformed embeddings produced by produced by the feed forward neural networks 216, feed forward neural networks 218 are configured to produce a set of encoded vectors that can be thought of as representing a series of probabilities across the entire token space, where each individual probability is referred to as a logit.

As a result of this processing by the feed forward neural network 218, the transformed set of token data takes the form of a 3D tensor with the following dimensions: N, S, D, where N is the number of textual embeddings being processed, S is the number of tokens encoded in the textual embeddings, and D is the embedding dimension, which is the size of the vector representing the token data.

In some embodiments, and like the feed forward neural network 216, the feed forward neural network 218 may comprise multiple sets of independent feed forward neural networks, with each feed forward neural network being initialized with a different state. In these embodiments, a respective textual embedding is processed in parallel by each independent feed forward neural network by engaging in the same types of mathematical computations described in the preceding paragraph, which results in a set of transformed textual embeddings for each textual embedding provided to the feed forward neural network 218. In this embodiment, as a result of processing by the multiple feed forward neural networks 218, the transformed set of embeddings takes the form of a tensor with the following dimensions: N, S, M*D, where N is the number of textual embeddings being processed, S is the number of tokens encoded in the textual embeddings, and M*D is a multiplication of (i) the size of the embedding dimension of each independent feed forward neural network and (ii) the number of independent feed forward neural networks.

As mentioned above, in addition to providing the image embeddings and the textual embeddings to the respective experts, the normalization functions 208, 212 also provide the normalized image embeddings and normalized textual embeddings to the learnable temperature function 214. The learnable temperature function 214 is configured to engage in a mathematical computation involving the normalized image embeddings and the normalized textual embeddings in order to produce respective temperature values, which will be applied by the router function 220 to each of the outputs from the feed forward neural networks 216, 218. In essence, the temperature values produced by the learnable temperature function 214 are designed to act as weights, with the temperature value computed based on the image embeddings acting as a weight dictating how much emphasis should be applied to the output of the feed forward neural network 216 when combining the results and the temperature value computed based on the textual embeddings acting as a weight dictating how much emphasis should be applied to the output of the feed forward neural network 218 when combing the results. In embodiments in which there are multiple sets of feed forward neural networks (such as, for example, multiple feed forward neural networks configured to process the image embeddings and multiple feed forward neural networks configured to process the textual embeddings), then the learnable temperature function 214 may be configured to produce a respective temperature value for each feed forward neural network. In this way, the respective temperature value for each feed forward neural network is designed to act as a weight dictating how much emphasis should be applied to the output of the corresponding feed forward neural network.

The temperature values produced by learnable temperature function 214 and the outputs produced by the feed forward neural networks 216, 218 are then provided to the router function 220. The router function 220 is configured to first engage in a mathematical computation by which the router 220 scales the outputs produced by the feed forward neural networks 216, 218 in accordance with the respective temperature values. In this respect, the router 220 engages in a first mathematical computation to scale the output produced by the feed forward neural network 216 in accordance with the temperature value produced by the learnable temperature function 214 for the image expert and engage in a second mathematical computation to scale the output produced by the feed forward neural network 218 in accordance with the temperature value produced by the learnable temperature function 214 for the textual expert. As a result, the router function 220 produces a set of scaled transformed image embeddings and a scaled set of transformed textual embeddings. Next, the router function 220 is configured to engage in a mathematical computation to combine the scaled transformed image embeddings and the scaled transformed textual embeddings by computing the dot product of these embeddings. The result of this dot product combination is a tensor with the following dimensions: N, S, M*D.

At this point, the resultant combination of transformed embeddings is provided to transformer 222. Transformer 222 is configured to receive the combined transformed embeddings and produce a natural language output that is responsive to the initial prompt. Transformer 222 may accomplish this by first engaging in a series of mathematical computations involving the embeddings that operate to decode each vector of the embeddings into a series of probabilities across the entire token space, where each individual probability is referred to as a logit. In other words, for each vector in the embedding, the transformer 222 is configured to, for each possible token that the architecture 200 understands, determine a respective probability corresponding to that token. In practice, most of the probabilities for the tokens will be at or near zero. Ideally, however, there are a handful of tokens for which the probabilities are relatively high. The transformer 222 is configured to, for each respective embedding, select the token corresponding to the highest probability logit. In this way, the transformer 222 constructs a series of tokens, each corresponding to the highest probability logit for each successive embedding. The transformer 222 then converts the tokens to natural language through a look-up table or the like.

The natural language output produced by transformer 222 is then provided to the back-end computing platform 102, which is configured to cause a client device 104 to display the natural language output to the user as a response to the user's prompt.

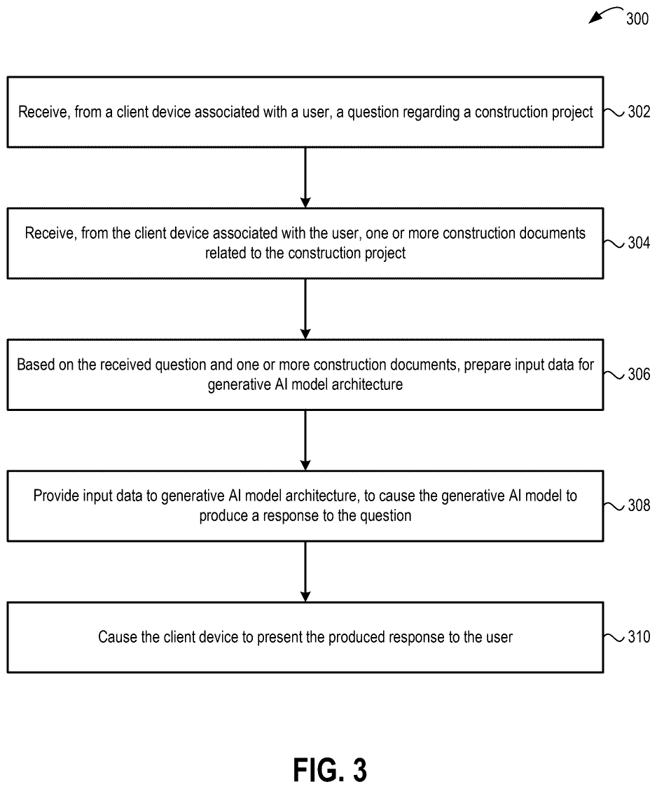

Turning to FIG. 3, example functionality 300 for using the software tool disclosed herein is illustrated in the form of a flow diagram. For purposes of illustration, the example functionality 300 of FIG. 3 is described as being carried out by the back-end computing platform 102 of FIG. 1, and more particularly by the back-end computing platform 102 utilizing the architecture 200 just described. In this respect, back-end computing platform 102 may host a construction management software application that utilizes architecture 200. However, it should be understood that the example functionality 300 of FIG. 3 may be carried out by any computing platform that is capable of running the software disclosed herein. Further, it should be understood that the example functionality of FIG. 3 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 3, the example functionality 300 may begin at block 302 with the back-end computing platform 102 receiving from a client device associated with a user, such as client device 104A, a question regarding a construction project. The client device 104A may be associated with a given user of the construction management software application. The question may take the form of a natural language prompt, which may be input by the user using an I/O device, such as a keyboard, touchscreen, or microphone. The prompt may then be sent over the communication path between the client device 104A and the back-end computing platform 102 in order for the input to be provided as the prompt to architecture 200. To facilitate receiving this input, the back-end computing platform may cause the client device 104A to present the user with a GUI tool through which the user can input the prompt. In this respect, the GUI tool may provide an input element, such as a text box or the like, through which the user can provide the prompt using any one of many possible I/O components connected to the client device 104.

For instance, one possible I/O component is a touch screen. In this case, the prompt may be received when the given user types the input on icons representing a keyboard on the touch-screen. As another possibility, if the I/O component is a keyboard, the prompt may be received when the user types the natural language prompt on the keyboard. And as yet another possibility, if the I/O device is a microphone, the prompt may be received when the user speaks a voice utterance into the microphone. Persons of skill in the art will recognize that the input may also take other forms to cause the client device 104A to send the input to the back-end computing platform 102.

As mentioned, the prompt may be sent over the communication path between the client device 104A and the back-end computing platform 102. In the case that the user typed the prompt via a keyboard or touch-screen keyboard, the prompt may be sent over the communication path in the form of a text string. In the case the user spoke the prompt, the prompt may be sent over the communication path in the form of an audio file containing the voice utterance. Once received, the back-end platform 102 may process the audio file containing the voice utterance with voice processing software in order to produce a natural language text string representing the voice utterance. Other examples are possible as well.

At block 304, the back-end computing platform 102 receives, from the client device associated with the user, one or more construction documents related to the construction project. These construction documents may take the form of electronic files, such as Word documents, PDF files, or construction drawing files. To facilitate this, the GUI tool presented to the user by client device 104A may include one or more types of mechanisms capable of receiving electronic files representing a construction document. As one possibility, the GUI tool may include an area within which the user may drag-and-drop a construction document stored elsewhere on the client device 104A, such as the internal storage of the client device 104A. As another possibility, the GUI tool may include a mechanism through which the user can inform client device 104A and/or back-end platform 102 from where to retrieve the construction document. In this respect, the GUI tool may include a selectable element, like a button, which upon selection presents the user with various options for the client device 104A and/or back-end platform 102 to retrieve the construction document. One option may enable the user to enter the location of the construction document, which could take the form of a location on the internal storage of the client device 104A or some other storage location accessible to client device 104A and/or back-end computing platform 102, such as a database or shared network storage or the like. Another option may enable the user to select a construction document from a set of construction documents already identified by the back-end computing platform. Upon receiving a selection of a given construction document, the client device 104A and/or the back-end computing platform 102 may then retrieve the selected construction document from a known location.

At block 306, the back-end computing platform 102, based on the received question and the one or more construction documents, prepares input data for the generative AI model architecture. In accordance with the above discussion, the back-end computing platform may prepare input data for the generative AI model architecture, such as architecture 200 in various ways. As one possibility, the back-end computing platform 102 may perform an OCR process on the construction document in order to recognize readable characters in the document and convert them to text. As another possibility, the back-end computing platform 102 may engage in an initial step of processing the construction document to separate the pixel data in the document from text contained in the document, which may include text that was recognized in the document by the OCR process. In this respect, the back-end computing platform 102 may produce a file or other set of data representing the pixel data in the document and may produce another file or other set of data representing the text in the document. As yet another possibility, the back-end computing platform 102 may obtain additional contextual data about the construction project, such as materials lists, change orders, budget data, communications, invoices, directories, time sheets, requests for information, reports, etc. The back-end computing platform 102 may obtain such additional contextual data from any one or more of various locations, including by way of example from another software application, from a data store accessible to back-end computing platform 102, or from another computing platform. In scenarios in which the back-end computing platform 102 obtains additional contextual data from another software application, the back-end computing platform 102 may utilize an API in order to communicate with such other software applications and thereby obtain such additional contextual data.

At block 308, the back-end computing platform 102 provides the prepared input data to the generative AI model architecture to cause the generative AI model to produce a response to the question. As explained previously, the back-end computing platform 102 may provide the prepared input data, which comprises the pixel data of the provided document, the text data of the provide document, the user's prompt, and any additional contextual data about the construction project, to the generative AI model of the disclosed software tool. The generative AI model of the disclosed software tool may take the form of architecture 200 (FIG. 2). Therefore, in the context of this step, the back-end computing platform 102 may cause the generative AI software tool to carry out the functions described above with reference to FIG. 2.

At block 310, the back-end computing platform 102 causes the client device to present the produced response to the user. To facilitate this, the back-end computing platform 102 may obtain the response produced by the generative AI software tool, and more particularly the response produced in accordance with architecture 200 engaging in the functional steps described above with respect to FIG. 2 and present this response to the user in any one of various ways. As one possibility, the back-end computing platform 102 may display the response to the user by way of a GUI tool. In this respect, the back-end computing platform 102 may cause client device 104A to present the user with a GUI that displays the response thereon. This GUI tool may be the same GUI tool as the one described above with respect to block 302. Alternatively, the back-end computing platform 102 may cause client device 104A to present the user with a new GUI tool and may cause client device 104A to display the response within the new GUI tool. As another possibility, back-end computing platform 102 may cause client device 104A to audibly output the response in the form of a natural language voice output. To facilitate this, the back-end computing platform 102 may utilize a text-to-speech software tool that converts the natural language response obtained from the generative AI software tool to an audio file that contains a speech representation thereof. The back-end computing platform 102 may then cause client device 104A to play the audio file. Other ways to cause the client device to present the produced response to the user are possible as well.

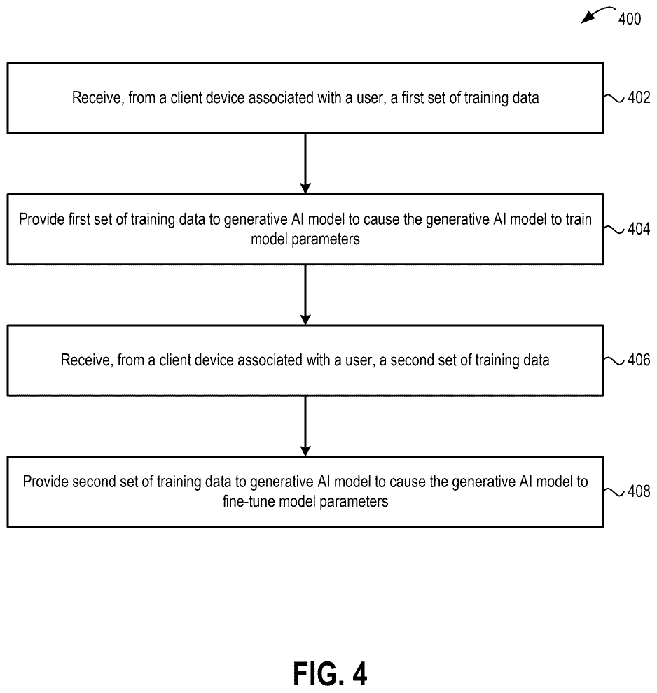

Turning to FIG. 4, one example of functionality 400 for training the generative AI model architecture 200 to produce outputs in accordance with the above discussion is illustrated. At a high-level, training a generative AI model involves providing input data to the model so that the various mathematical computations performed by the model during normal operation will ultimately result in a relevant and responsive output. In this respect, training data provided to the generative AI model is typically purposefully enriched with additional information so that the generative AI model can use the training data and the additional information in order to tune its mathematical computations in ways that will enable the generative AI model, during normal operation, to receive, process, and thereby understand, data that may not be so enriched.

Still at a high-level and before discussing the functional steps of the example process for training, training of the generative AI model architecture 200 may take the form of a two-stage process. In the first stage, a set of pre-training data is provided to the functional blocks of the architecture 200. This pre-training data may take the form of raw image-text pairs curated by a user. In practice, these raw-image text pairs may comprise images of features that commonly appear within construction drawings as well as text associated with the images that describe in words what the features are and what they represent. By way of example, one raw image-text pair may be a portion of a construction drawing depicting a room boundary to be constructed and corresponding text that reads “boundary of room.” As another example, another raw image-text pair may be a portion of construction drawing depicting a set of stairs and corresponding text that reads “stairs.” In this respect, during the training process, the architecture 200 will tune its mathematical computations in ways designed to associate the images depicted in the raw image-text pairs with the words that correspond to the images in the raw image-text pairs.

In the second stage, a set of conversational data is provided to the functional blocks of the architecture 200. This set of conversational data may take the form of question-answer pairs, which may also be curated by a user. By way of example, one question-answer pair may be text, such as “Q: What are the dimensions of the kitchen? A: 10 feet by 12 feet.” In this respect, during the training process, the architecture 200 will tune its mathematical computations in ways designed to understand what types of answers are provided to various types of questions that users may ultimately ask about construction projects during normal operation of the generative AI model. Accordingly, and still by way of example, by processing the question-answer pairs like the one described in the example above, the generative AI model will tune its mathematical computations in ways designed to understand that when a user's question asks for dimensions or sizes or the like that the responsive output should be one that includes units of measurement, like inches or feet.

Turning back to FIG. 4, example functionality 400 for using the software tool disclosed herein is illustrated in the form of a flow diagram. For purposes of illustration, the example functionality 400 of FIG. 4 is described as being carried out by the back-end computing platform 102 of FIG. 1, and more particularly by the back-end computing platform 102 utilizing the architecture 200 just described. In this respect, and as discussed, back-end computing platform 102 may host a construction management software application that utilizes architecture 200. However, it should be understood that the example functionality 400 of FIG. 4 may be carried out by any computing platform that is capable of running the software disclosed herein. Further, it should be understood that the example functionality of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 3, the example functionality 400 may begin at block 402 with the back-end computing platform 102 receiving from a client device associated with a user, such as client device 104A, a first set of training data. As mentioned above, this first set of training data may comprise what is referred to as pre-training data, which may more specifically take the form of raw image-text pairs. A raw image-text pair is generally an image of a construction feature that the model may encounter during normal operation and text associated with the image that describes in words what the features are and what they represent. By way of example, one raw image-text pair may be a portion of a construction drawing depicting a room boundary to be constructed and corresponding text that reads “boundary of room.” As another example, another raw image-text pair may be a portion of construction drawing depicting a set of stairs and corresponding text that reads “stairs.” In practice, the first set of training data may be embodied within one or more electronic files, such as PDFs or CAD files that contain data representing one or more raw image-text pairs, which may be curated by the user associated with the client device 104A or another construction professional.

To facilitate receiving the first set of training data, client device 104A may present to the user associated with the client device 104A a GUI tool that includes one or more types of mechanisms capable of receiving electronic files representing this first set of training data. Like the GUI tools described above with respect to FIG. 3, as one possibility, the GUI tool may include an area within which the user may drag-and-drop an electronic file representing the first set of training data stored elsewhere on the client device 104A, such as the internal storage of the client device 104A. As another possibility, the GUI tool may include a mechanism through which the user can inform client device 104A and/or back-end platform 102 from where to retrieve the electronic file representing the first set of training data. In this respect, the GUI tool may include a selectable element, like a button, which upon selection presents the user with various options for the client device 104A and/or back-end platform 102 to retrieve the electronic file representing the first set of training data. One option may enable the user to enter the location of the electronic file representing the first set of training data, which could take the form of a location on the internal storage of the client device 104A or some other storage location accessible to client device 104A and/or back-end computing platform 102, such as a database or shared network storage or the like. Another option may enable the user to select an electronic file representing the first set of training data from a set of construction documents already identified by the back-end computing platform. Upon receiving a selection of a given electronic file representing the first set of training data, the client device 104A and/or the back-end computing platform 102 may then retrieve the selected electronic file representing the first set of training data from a known location.

At block 404, the back-end computing platform 102 provides the first set of training data to the generative AI model architecture 200 to cause the generative AI model to train model parameters. The architecture 200, and in particular the transformers 204, 210, 222, the learnable temperature function 214, and the feed forward neural networks 216, 218 process the first set of training data by engaging in an iterative set of mathematical computations designed to establish a foundational understanding of the relationship between the visual features depicted in the images of the first set of training data and the corresponding text of the first set of training data. Through this training, the architecture 200, and in particular the transformers 204, 210, 222, the learnable temperature function 214, and the feed forward neural networks 216, 218, are configured to adjust parameters that are used to carry out the mathematical computations performed during normal operation in certain ways such that the architecture 200 will produce, during normal operation, embeddings that accurately encode the visual and textual features of data and will operate to generate accurate responses. In this respect, the transformers 204, 210, and 222 are configured to adjust parameters that enable the transformers 204, 210 to receive image and textual data and then encode such data with token data and vector embeddings that represent the visual and textual features. And the feed forward neural networks 216, 218 are configured to adjust parameters that enable the feed forward neural networks 216, 218 to receive embeddings and produce transformed embeddings that represent a series of probabilities for successive generated tokens, which can then be converted into a natural language response.

Next, at block 406, the back-end computing platform 102 receives from a client device associated with a user, such as client device 104A, a second set of training data. As mentioned above, this second set of training data may take the form of data designed to fine-tune the model parameters in order to increase the accuracy of the generative AI model. In some embodiments, the second set of training data may take the form of question-answer pairs, which may, like the raw image-text pairs comprising the first set of training data, be curated by a user associated with client device 104A and/or another construction professional.

As described above, and by way of example, one question-answer pair may be text, such as “Q: What are the dimensions of the kitchen? A: 10 feet by 12 feet.” In this respect, during the training process, the architecture 200 will fine tune parameters, which are used by the generative AI model to carry out the mathematical computations during normal operation, in ways designed to enable the generative AI model to understand what types of answers are provided to various types of questions that users may ultimately ask about construction projects during normal operation of the generative AI model. Accordingly, and still by way of example, by processing the question-answer pairs like the one described in the example above, the generative AI model will tune its mathematical computations in ways designed to understand that when a user's question asks for dimensions or sizes or the like that the responsive output should be one that includes units of measurement, like inches or feet.

In practice, the second set of training data may be embodied within one or more electronic files, such as PDFs or other text files that contain data representing one or more question-answer pairs, which may be curated by the user associated with the client device 104A or another construction professional.

To facilitate receiving the first set of training data, client device 104A may present to the user associated with the client device 104A a GUI tool that includes one or more types of mechanisms capable of receiving electronic files representing this second set of training data. Like the GUI tools described above, as one possibility, the GUI tool may include an area within which the user may drag-and-drop an electronic file representing the second set of training data stored elsewhere on the client device 104A, such as the internal storage of the client device 104A. As another possibility, the GUI tool may include a mechanism through which the user can inform client device 104A and/or back-end platform 102 from where to retrieve the electronic file representing the second set of training data. In this respect, the GUI tool may include a selectable element, like a button, which upon selection presents the user with various options for the client device 104A and/or back-end platform 102 to retrieve the electronic file representing the second set of training data. One option may enable the user to enter the location of the electronic file representing the second set of training data, which could take the form of a location on the internal storage of the client device 104A or some other storage location accessible to client device 104A and/or back-end computing platform 102, such as a database or shared network storage or the like. Another option may enable the user to select an electronic file representing the second set of training data from a set of construction documents already identified by the back-end computing platform. Upon receiving a selection of a given electronic file representing the second set of training data, the client device 104A and/or the back-end computing platform 102 may then retrieve the selected electronic file representing the second set of training data from a known location.

Next, at block 408, the back-end computing platform 102 provides the second set of training data to the generative AI model architecture 200 to cause the generative AI model to fine-tune model parameters. The architecture 200, and in particular the transformers 204, 210, 222, the learnable temperature function 214, and the feed forward neural networks 216, 218 process the second set of training data by engaging in an iterative set of mathematical computations designed to target specific aspects of the model computations in order to configure the model to more accurately process the construction-related vocabulary that the model will typically encounter during normal operation. Through this training, the architecture 200, and in particular the attention processes of the transformers 204, 210, 222 and the feed forward neural networks 216, 218, are configured to adjust parameters that are used to carry out the mathematical computations performed during normal operation in certain ways such that the architecture 200 will produce, during normal operation, embeddings that accurately encode the visual and textual features of data as well as generate more accurate responses. In some embodiments, the generative AI model will engage in a specific fine-tuning process using the second set of training data known as Low Rank Adaption (LoRA) in order to make adjustments to the parameters used by the transformers to engage in the mathematical computations that produce the embeddings described above. In particular, by using a LoRA process, low-rank matrices with particular parameters will be injected into the functional processes of the transformers and feed forward neural networks such that the transformers and feed forward neural networks will engage in mathematical computations using these low-rank matrices in order to produce embeddings and transformed embeddings. In this respect, the transformers 204, 210, and 222 are configured to adjust parameters that enable the transformers 204, 210 to receive image and textual data and then encode such data with token data and vector embeddings that represent the visual and textual features. And the feed forward neural networks 216, 218 are configured to adjust parameters that enable the feed forward neural networks 216, 218 to receive embeddings and produce transformed embeddings that represent a series of probabilities for successive generated tokens, which can then be converted into a natural language response. As a result of this training process, the set of parameters produced by the training process are retained by the generative AI model, and in particular the transformers 204, 210, 222 and the feed forward neural networks 216, 218 and then utilized by these functions to perform the mathematical computations during normal operation of the generative AI model. With respect to the feed forward neural networks, the set of parameters produced by the training process are embodied as the initialization state of the feed forward neural networks.

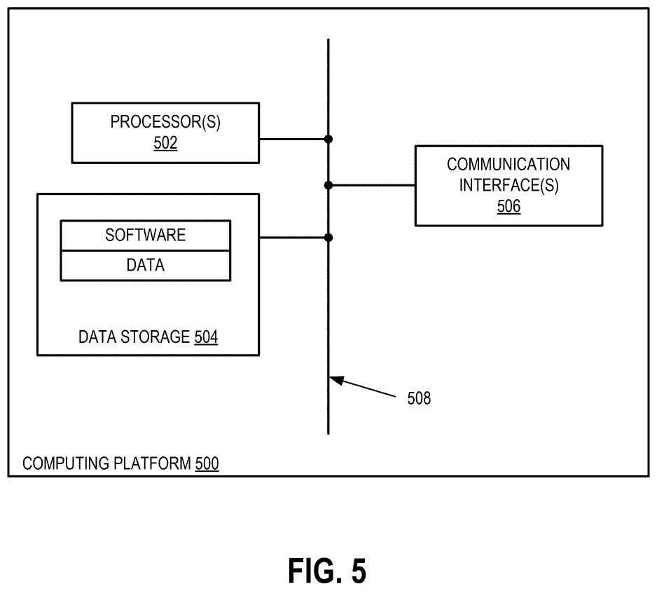

Turning now to FIG. 5, a simplified block diagram is provided to illustrate some structural components that may be included in an example computing platform 500 that may be configured to perform the functions described above with respect to architecture 200 (FIG. 2). At a high level, the example computing platform 500 may generally comprise any one or more computer systems (e.g., one or more servers) that collectively include one or more processors 502, data storage 504, and one or more communication interfaces 506, each of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, the data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, the data storage 504 may be capable of storing both (i) program instructions that are executable by the one or more processors 502 such that the example computing platform 500 is configured to perform any of the various functions disclosed herein (including but not limited to any of the functions described as being performed by the various functional blocks of architecture 200), and (ii) data that may be received, derived, or otherwise stored by the example computing platform 500.

The one or more communication interfaces 506 may comprise one or more interfaces that facilitate communication between the example computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 500 may additionally have an Input/Output (I/O) interface that includes or provides connectivity to I/O components that facilitate user interaction with the example computing platform 500, such as a keyboard, a mouse, a trackpad, a display screen, a touch-sensitive interface, a stylus, a virtual-reality headset, and/or one or more speaker components, among other possibilities.

It should be understood that the example computing platform 500 is one example of a computing platform that may be used with the examples described herein. Numerous other arrangements are possible and contemplated herein. For instance, in other examples, the example computing platform 500 may include additional components not pictured and/or more or less of the pictured components.

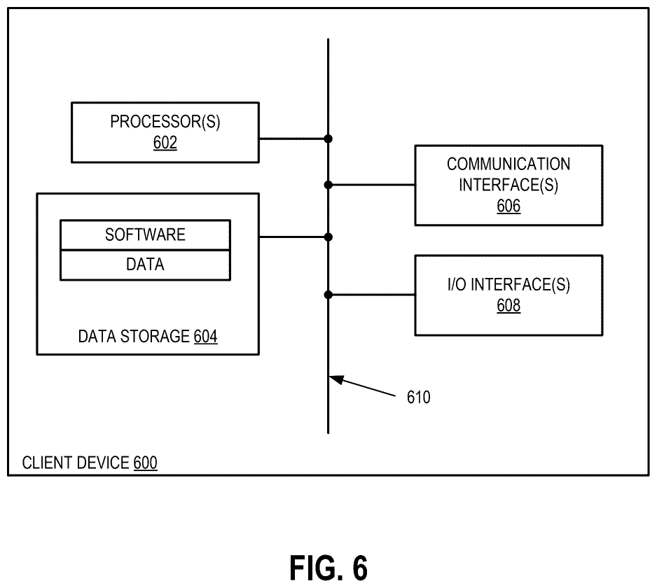

Turning next to FIG. 6, a simplified block diagram is provided to illustrate some structural components that may be included in an example client device 600 that may be configured to perform some the client-side functions disclosed herein. At a high level, the example client device 600 may include one or more processors 602, data storage 604, one or more communication interfaces 606, and an I/O interface 608, each of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, the data storage 604 may be capable of storing both (i) program instructions that are executable by the one or more processors 602 of the example client device 600 such that the example client device 600 is configured to perform any of the various functions disclosed herein (including but not limited to any of the client-side functions discussed above), and (ii) data that may be received, derived, or otherwise stored by the example client device 600.

The one or more communication interfaces 606 may comprise one or more interfaces that facilitate communication between the example client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a given user). In this respect, the one or more input interfaces of I/O interface may include or provide connectivity to input components such as a microphone, a camera, a keyboard, a mouse, a trackpad, a touchscreen, an accelerometer, a gyroscope, a location signal receiver (e.g., a cellular signal receiver, a Wi-Fi Positioning System (WPS) receiver, a Bluetooth receiver, a Radio Frequency Identification (RFID) receiver, an Ultra-Wideband (UWB) receiver, a magnetic field receiver, a satellite signal receiver such as a GPS, etc.), and/or a stylus, among other possibilities, and the one or more output interfaces of the I/O interface 608 may include or provide connectivity to output components such as a display screen and/or an audio speaker, among other possibilities.

It should be understood that the example client device 600 is one example of a client device that may be used with the examples described herein. Numerous other arrangements are possible and contemplated herein. For instance, in other examples, the example client device 600 may include additional components not pictured and/or more or fewer of the pictured components.

Examples of the disclosed innovations have been described above. Those skilled in the art will understand, however, that changes and modifications may be made to the examples described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
receive from a client device associated with a user, a question regarding a construction project;
receive, from the client device associated with the user, one or more construction documents related to the construction project;
based on the received question and the one or more construction documents, prepare input data for a generative AI model;
provide the prepared input data to the generative AI model architecture to cause the generative AI model to produce a response to the question; and
cause the client device to present the produced response to the user.

2. The computing platform of claim 1, wherein the generative AI model comprises:
one or more image transformers configured to produce image embeddings;
one or more textual transformers configured to produce text embeddings;
one or more first feed forward neural networks configured to produce transformed image embeddings; and
one or more second feed forward neural networks configured to produce transformed text embeddings.

3. The computing platform of claim 1, wherein the program instructions that, when executed by the at least one processor, cause the computing platform to, based on the received question and the one or more construction documents, prepare input data for a generative AI model comprise program instructions that, when executed by the at least one processor, cause the computing platform to:
extract image data associated with the one or more construction documents;
extract textual data from the received question and from the one or more construction documents.

4. The computing platform of claim 3, wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
route the extracted image data to the one or more image transformers to cause the one or more image transformers to produce one or more image embeddings;
route the one or more image embeddings to the one or more first feed forward neural networks to cause the one or more first feed forward neural networks to produce transformed image embeddings;
route the extracted textual data to the one or more text transformers to cause the one or more text transformers to produce one or more text embeddings; and
route the one or more text embeddings to the one or more second feed forward neural networks to cause the one or more second feed forward neural networks to produce transformed text embeddings.

5. The computing platform of claim 4, wherein the generative AI model comprises:
a router configured to combine the transformed image embeddings and the transformed text embeddings in accordance with learnable temperature parameters; and
an output transformer configured to produce, from the combination of the transformed image embeddings and the transformed text embeddings a response to the question, and
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
determine a set of respective temperature parameters, with each respective temperature parameter corresponding to one of the first and second feed forward neural networks;
route the transformed image embeddings and transformed text embeddings to the router to cause the router to combine the transformed image embeddings and the transformed text embeddings in accordance with the respective temperature parameters into a combined transformed embedding; and
route the combined transformed embedding to the output transformer to cause the output transformer to produce a response to the question based on the combined transformed embedding.

6. The computing platform of claim 4, wherein the one or more image embeddings comprise a set of vector embeddings, each vector embedding in the set of vector embeddings having a first embedding dimension, wherein the set of vector embeddings represents an encoding of token data for tokens identified in the image;
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
reduce the embedding dimension of the set of vector embeddings from the first embedding dimension to a second embedding dimension.

7. The computing platform of claim 4, wherein the program instructions that, when executed by the at least one processor, cause the computing platform to, extract image data from the one or more construction documents, comprise program instructions that, when executed by the at least one processor, cause the computing platform to:
divide the extracted image data associated with the one or more construction documents into a plurality of image patches, wherein the plurality of image patches collectively represent the image data associated with the one or more construction documents, and
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
route the plurality of image patches to the one or more image transformers to cause the one or more image transformers to produce a respective image embedding for each of the plurality of image patches;
route the respective image embeddings to the one or more first feed forward neural networks to cause the one or more first feed forward neural networks to produce a respective transformed image embedding for each of the respective image embeddings.

8. A non-transitory computer-readable medium, wherein the non-transitory computer-readable medium is provisioned with program instructions that, when executed by at least one processor, cause a computing platform to:
receive from a client device associated with a user, a question regarding a construction project;
receive, from the client device associated with the user, one or more construction documents related to the construction project;
based on the received question and the one or more construction documents, prepare input data for a generative AI model;
provide the prepared input data to the generative AI model architecture to cause the generative AI model to produce a response to the question; and
cause the client device to present the produced response to the user.

9. The non-transitory computer-readable medium of claim 8, wherein the generative AI model comprises:
one or more image transformers configured to produce image embeddings;
one or more textual transformers configured to produce text embeddings;
one or more first feed forward neural networks configured to produce transformed image embeddings; and
one or more second feed forward neural networks configured to produce transformed text embeddings.

10. The non-transitory computer-readable medium of claim 8, wherein the program instructions that, when executed by the at least one processor, cause the computing platform to, based on the received question and the one or more construction documents, prepare input data for a generative AI model comprise program instructions that, when executed by the at least one processor, cause the computing platform to:
extract image data associated with the one or more construction documents;
extract textual data from the received question and from the one or more construction documents.

11. The non-transitory computer-readable medium of claim 10, wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
route the extracted image data to the one or more image transformers to cause the one or more image transformers to produce one or more image embeddings;
route the one or more image embeddings to the one or more first feed forward neural networks to cause the one or more first feed forward neural networks to produce transformed image embeddings;
route the extracted textual data to the one or more text transformers to cause the one or more text transformers to produce one or more text embeddings; and
route the one or more text embeddings to the one or more second feed forward neural networks to cause the one or more second feed forward neural networks to produce transformed text embeddings.

12. The non-transitory computer-readable medium of claim 11, wherein the generative AI model comprises:
a router configured to combine the transformed image embeddings and the transformed text embeddings in accordance with learnable temperature parameters; and
an output transformer configured to produce, from the combination of the transformed image embeddings and the transformed text embeddings a response to the question, and
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
determine a set of respective temperature parameters, with each respective temperature parameter corresponding to one of the first and second feed forward neural networks;
route the transformed image embeddings and transformed text embeddings to the router to cause the router to combine the transformed image embeddings and the transformed text embeddings in accordance with the respective temperature parameters into a combined transformed embedding; and
route the combined transformed embedding to the output transformer to cause the output transformer to produce a response to the question based on the combined transformed embedding.

13. The non-transitory computer-readable medium of claim 11, wherein the one or more image embeddings comprise a set of vector embeddings, each vector embedding in the set of vector embeddings having a first embedding dimension, wherein the set of vector embeddings represents an encoding of token data for tokens identified in the image;
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
reduce the embedding dimension of the set of vector embeddings from the first embedding dimension to a second embedding dimension.

14. The non-transitory computer-readable medium of claim 11, wherein the program instructions that, when executed by the at least one processor, cause the computing platform to, extract image data from the one or more construction documents, comprise program instructions that, when executed by the at least one processor, cause the computing platform to:
divide the extracted image data associated with the one or more construction documents into a plurality of image patches, wherein the plurality of image patches collectively represent the image data associated with the one or more construction documents, and
wherein the program instructions that, when executed by the at least one processor, cause the computing platform to provide the prepared input data to the generative AI model architecture to cause the generative AI model to produce a response to the question comprise program instructions that, when executed by the at least one processor, cause the computing platform to:
route the plurality of image patches to the one or more image transformers to cause the one or more image transformers to produce a respective image embedding for each of the plurality of image patches;
route the respective image embeddings to the one or more first feed forward neural networks to cause the one or more first feed forward neural networks to produce a respective transformed image embedding for each of the respective image embeddings.

15. A method comprising:
receiving from a client device associated with a user, a question regarding a construction project;
receiving, from the client device associated with the user, one or more construction documents related to the construction project;
based on the received question and the one or more construction documents, preparing input data for a generative AI model;
providing the prepared input data to the generative AI model architecture to cause the generative AI model to produce a response to the question; and
causing the client device to present the produced response to the user.

16. The method of claim 15, wherein the generative AI model comprises:
one or more image transformers configured to produce image embeddings;
one or more textual transformers configured to produce text embeddings;
one or more first feed forward neural networks configured to produce transformed image embeddings; and
one or more second feed forward neural networks configured to produce transformed text embeddings.

17. The method of claim 15, wherein, based on the received question and the one or more construction documents, preparing input data for a generative AI model comprises:
extracting image data associated with the one or more construction documents;
extracting textual data from the received question and from the one or more construction documents.

18. The method of claim 17, wherein providing the prepared input data to the generative AI model architecture to cause the generative AI model to produce a response to the question comprises:
routing the extracted image data to the one or more image transformers to cause the one or more image transformers to produce one or more image embeddings;
routing the one or more image embeddings to the one or more first feed forward neural networks to cause the one or more first feed forward neural networks to produce transformed image embeddings;
routing the extracted textual data to the one or more text transformers to cause the one or more text transformers to produce one or more text embeddings; and
routing the one or more text embeddings to the one or more second feed forward neural networks to cause the one or more second feed forward neural networks to produce transformed text embeddings.

19. The method of claim 17, wherein the generative AI model comprises:
a router configured to combine the transformed image embeddings and the transformed text embeddings in accordance with learnable temperature parameters; and
an output transformer configured to produce, from the combination of the transformed image embeddings and the transformed text embeddings a response to the question, and
wherein providing the prepared input data to the generative AI model architecture to cause the generative AI model to produce a response to the question comprises:
determining a set of respective temperature parameters, with each respective temperature parameter corresponding to one of the first and second feed forward neural networks;
routing the transformed image embeddings and transformed text embeddings to the router to cause the router to combine the transformed image embeddings and the transformed text embeddings in accordance with the respective temperature parameters into a combined transformed embedding; and
routing the combined transformed embedding to the output transformer to cause the output transformer to produce a response to the question based on the combined transformed embedding.

20. The method of claim 17, wherein the one or more image embeddings comprise a set of vector embeddings, each vector embedding in the set of vector embeddings having a first embedding dimension, wherein the set of vector embeddings represents an encoding of token data for tokens identified in the image, and
wherein providing the prepared input data to the generative AI model architecture to cause the generative AI model to produce a response to the question comprises:
reducing the embedding dimension of the set of vector embeddings from the first embedding dimension to a second embedding dimension.
